(19) United States
(12) Patent Application Publication
(10) Pub. No.: US 2026/0043717 A1
(43) Pub. Date: Feb. 12, 2026

(54) STATION FOR MEASURING AIRBORNE MOLECULAR CONTAMINATION

(71) Applicant: PFEIFFER VACUUM, Annecy (FR)

(72) Inventors: Olivier LE BARILLEC, Annecy Cedex (FR); Julien BOUNOUAR, Annecy Cedex (FR)

(73) Assignee: PFEIFFER VACUUM, Annecy (FR)

(21) Appl. No.: 19/103,052

(22) PCT Filed: Sep. 14, 2023
(86) PCT No.: PCT/EP2023/075262

§ 371 Date: Feb. 11, 2025

(30) Foreign Application Priority Data
Sep. 20, 2022 (FR) 2209475

(51) Int. Cl. G01N 1/24; G01N 15/06

(52) U.S. Cl. CPC G01N 1/24; G01N 15/06

(57) ABSTRACT

A measuring station for measuring airborne molecular contamination includes at least one gas analyzer and at least one sampling line fluidically connected to an inlet of the gas analyzer. The station includes at least one sampling pump arranged upstream of the gas analyzer in the flow direction of a gas flow to be pumped, and the sampling pump has a suction side fluidically connected to the at least one sampling line and a discharge side fluidically connected to the inlet of the gas analyzer. The sampling pump is able to draw a gas flow from the sampling line, and to discharge the gas flow at atmospheric pressure +/−50 hPa, preferably +/−30 hPa.

The present invention relates to a station for measuring airborne molecular contamination. The measuring station can be used in particular to monitor concentrations of atmospheric molecular contamination in clean rooms, such as the clean rooms in semiconductor manufacturing plants.

In the semiconductor manufacturing industry, substrates such as semiconductor wafers or photomasks must be protected from airborne molecular contamination (AMC), which can cause damage to the electronic circuits or chips of the substrates. For this purpose, the substrates are contained in atmospheric storage and transport boxes, allowing the substrates to be transported from one piece of equipment to another or stored between two manufacturing steps. Furthermore, the transport boxes and equipment are arranged inside clean rooms in which particle levels are minimized and temperature, humidity and pressure are maintained at precise levels.

In clean rooms, airborne gaseous species can have different sources and different natures, for example acids, bases, condensable elements, and doping elements. These molecules can come from the air inside the semiconductor manufacturing plant or can be released notably by semiconductor wafers that have undergone prior manufacturing operations.

Gas analyzers present in clean rooms make it possible to evaluate the concentration of airborne gaseous species at atmospheric pressure in real time, notably for humidity and some acids. Since these gas analyzers measure the surrounding gaseous atmosphere, it is generally necessary to provide a gas analyzer in each zone to be tested of the clean room.

There is a need to increase the number of gaseous species measured and the number of test zones in order to reduce the risks of contamination of the substrates. However, increasing the number of gas analyzers in each zone and increasing the number of zones to be tested rapidly makes this solution very costly.

To reduce the costs, a measurement unit that combines different analyzers has been proposed. These analyzers are chosen in consideration of the gas chemistry and the nature of the gaseous species to be measured. The measurement unit is equipped with several inlet ports, each addressing a particular test zone of the clean room. Since clean rooms can be large and the number of test zones is also increasing, a significant number of sampling lines may be required. The sampling lines allow air to be conveyed from the test zones to the gas analyzers. These lines are usually tens of meters long, even hundreds of meters long.

One solution is to draw a gas flow into all of the sampling lines, usually one after the other. Different gas chemistries may be measured simultaneously, depending on the number of analyzers present. Since each analyzer is independent of the others, the suction flow may be different in the sampling lines.

However, since some sampling lines can be very long, notably several hundred meters long, a vacuum may be observed at the inlet of the gas analyzers. This is because the sampling lines generally have a small diameter, notably around a quarter inch (6.35 mm), which restricts the gas flow. The vacuum is also partly related to the flow drained by the analyzers.

Depending on the gas-analyzer technology used, such a vacuum may cause one or more gas analyzers to cease taking measurements within their working pressure range or normal operating range around atmospheric pressure, which may result in inaccurate or unusable measurement results. This is for example the case with an ion mobility spectrometry (IMS) gas analyzer.

One possible solution is to increase the diameter of the sampling lines, thereby increasing conductance and thus limiting the resulting vacuum. However, this solution involves increasing the internal surfaces of the lines able to adsorb the gases. These sampling lines may subsequently release some of the gaseous species conveyed, which may complicate interpretation of the measurement results. In order to limit this, it is preferable to use a material of very high purity with a very smooth internal surface finish to make the sampling lines. This may notably be a fluorine-enriched material, such as a fluoropolymer, for example perfluoroalkoxy alkane (PFA) or polytetrafluoroethylene (PTFE).

However, increasing the diameter of each sampling line, of which there may be as many as one or two hundred, over a length of up to several hundred meters, with such a specific material, considerably increases the overall cost of the measurement unit.

Moreover, the sampling lines usually undergo conditioning before a new measurement in order to eliminate the memory effect of the lines in certain applications, notably when the gaseous species to be monitored are particularly adherent to the walls. The increase in diameter increases the degassing time and consequently the conditioning time for each sampling line.

Another possible solution involves reducing the length of the sampling lines, for example to a few tens of meters, or limiting the number of gas analyzers. However, such solutions are of very limited interest.

One of the aims of the present invention is to propose a measuring station that at least partially resolves one or more of the aforementioned draw backs.

To this end, the invention relates to a station for measuring airborne molecular contamination comprising at least one gas analyzer and at least one sampling line fluidically connected to an inlet of the at least one gas analyzer. According to the invention, said station comprises at least one sampling pump arranged upstream of the at least one gas analyzer in the flow direction of a gas flow to be pumped. The sampling pump has a suction side fluidically connected to the at least one sampling line and a discharge side fluidically connected to the inlet of the at least one gas analyzer. The sampling pump is configured to draw the gas flow from the at least one sampling line, and to discharge the gas flow at atmospheric pressure +/−50 hPa, i.e. +/−50 mbar. Preferably, the sampling pump is configured to discharge the gas flow at atmospheric pressure +/−30 hPa, i.e. +/−30 mbar.

Such a sampling pump upstream of the at least one gas analyzer enables the gas flow to be drained to the inlet of the gas analyzer, discharging the gas flow at or around atmospheric pressure and thereby limiting the risk of pressure variations at the inlet of the gas analyzer. This enables any technology to be used for the analyzer or several gas analyzers, with no limitation on the number of gas analyzers.

Said station may further comprise one or more of the features described below, taken separately or in combination.

One or more elements upstream of the gas analyzer or analyzers may have an internal surface made of a fluoropolymer, such as perfluoroalkoxy alkane or polytetrafluoroethylene or a perfluoroelastomer.

The sampling pump may have an internal surface made of fluoropolymer, such as perfluoroalkoxy alkane or polytetrafluoroethylene or a perfluoroelastomer.

The at least one sampling line may have an internal surface made of fluoropolymer, such as perfluoroalkoxy alkane or polytetrafluoroethylene or a perfluoroelastomer.

Said station may have at least one buffer volume arranged downstream of the sampling pump and upstream of the at least one gas analyzer, in the flow direction of the gas flow to be pumped.

The buffer volume may be between 60 cm³, or 60 mL, and 1 dm³, or IL.

The buffer volume may have a generally cylindrical shape.

The buffer volume may have an internal surface made of fluoropolymer, such as perfluoroalkoxy alkane or polytetrafluoroethylene or a perfluoroelastomer.

Said station may include at least one pressure gauge.

According to a variant, the pressure gauge may be arranged downstream of the sampling pump.

The pressure gauge may be arranged downstream of the buffer volume in the flow direction of the gas flow to be pumped.

According to another variant, the pressure gauge may be arranged upstream of the sampling pump.

The pressure gauge may have an internal surface made of fluoropolymer, such as perfluoroalkoxy alkane or polytetrafluoroethylene or a perfluoroelastomer.

The at least one gas analyzer is configured to operate at atmospheric pressure or

substantially at atmospheric pressure.

The sampling pump may be a diaphragm pump.

The at least one gas analyzer may have an internal pump.

The internal pump may be a diaphragm pump.

Said station may comprise at least two sampling lines fluidically connected to a common suction line.

At least one of the lines may have a minimum length, for example at least 50 m.

The common suction line may be fluidically connected to the suction side of the sampling pump.

The common suction line may have an internal surface made of fluoropolymer, such as perfluoroalkoxy alkane or polytetrafluoroethylene or a perfluoroelastomer.

For example, said station comprises at least one valve configured to selectively allow fluidic communication or fluidic isolation between the sampling pump and at least one of the sampling lines.

The at least one valve is, for example, a controllable valve.

The at least one valve may have an internal surface made of fluoropolymer, such as perfluoroalkoxy alkane or polytetrafluoroethylene or a perfluoroelastomer.

Said station may include a control unit configured to control the at least one controllable valve.

The sampling pump may be arranged upstream of at least two gas analyzers. The discharge side of the sampling pump is fluidically connected to the inlet of the gas analyzers by a common discharge line.

The gas analyzers may be connected to the common discharge line.

The gas analyzers may be connected in parallel.

The common discharge line may be fluidically connected to an exhaust.

The common discharge line may have an internal surface made of fluoropolymer, such as perfluoroalkoxy alkane or polytetrafluoroethylene or a perfluoroelastomer.

Said station may include at least one flowmeter. Advantageously, the flowmeter May be arranged on the common discharge line downstream of the gas analyzers in the flow direction of the gas flow to be pumped. The flowmeter is configured to measure the flow rate of the gas flow in the common discharge line.

Said station may comprise at least one restriction upstream of the sampling pump in the flow direction of the gas flow to be pumped.

The restriction may have a variable opening. The opening of the restriction may be configured to be controlled as a function of a pressure measured by the pressure gauge fluidically connected to the discharge side of the sampling pump.

The restriction may be achieved using at least one flow regulator, such as a screw-adjusted flow regulator.

According to another example, the restriction may be achieved using at least one calibrated orifice.

The restriction may have an internal surface made of fluoropolymer, such as perfluoroalkoxy alkane or polytetrafluoroethylene or a perfluoroelastomer.

Other advantages and features of the invention will become more clearly apparent on reading the following description, which is given by way of illustrative and nonlimiting example, and the sole FIGURE:

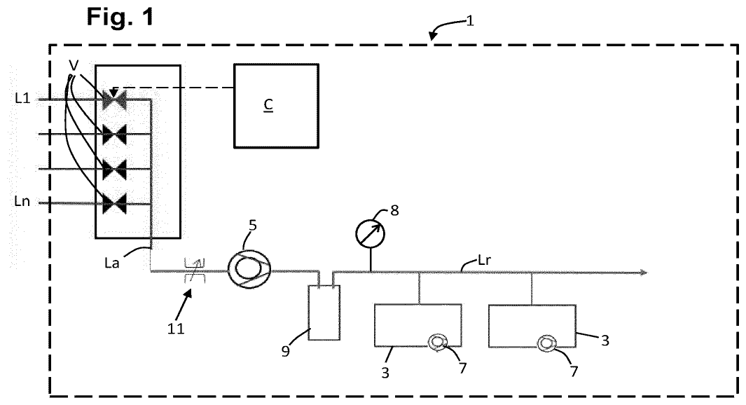

FIG. 1 is a schematic view of an example of an embodiment of a station for measuring airborne molecular contamination.

The following embodiments are examples. Although the description refers to one or more embodiments, this does not necessarily mean that each reference relates to the same embodiment, or that the features apply only to one embodiment. Individual features of different embodiments can also be combined or interchanged to provide other embodiments.

In the description, some elements may be indexed, for example first element or second element. In this case, this indexing is merely intended to differentiate and identify elements that are similar but not identical. This indexing does not imply that one element takes priority over another and such denominations can easily be interchanged without moving outside the scope of the present invention. This indexing also does not imply an order in time.

The term “upstream” is understood to mean an element that is placed before another with respect to the flow direction of the gas or gas flow to be pumped. By contrast, the term “downstream” is understood to mean an element that is placed after another with respect to the flow direction of the gas or gas flow to be pumped.

FIG. 1 shows an example of a measuring station 1 for measuring airborne molecular contamination. The measuring station 1 can be used in particular to monitor concentrations of atmospheric molecular contamination in clean rooms, such as the clean rooms in semiconductor manufacturing plants.

The measuring station 1 comprises a predefined number of gas analyzers 3, one or more sampling lines L1-Ln and at least one sampling pump 5.

A gas analyzer 3 enables the concentration of at least one gaseous species to be measured. The gaseous species measured is for example an acid, such as hydrofluoric acid (formula HF) or hydrochloric acid (formula HCl). According to another example, the gaseous species measured is a volatile organic compound (VOC) or ammonia (formula NH₃) or an amine. The gaseous species measured may also be sulfur dioxide (formula SO₂) or a sulfur compound, or ozone (formula O₃) or nitrogen oxide (formula NOₓ), water vapor, or at least one doping agent. The gas analyzer 3 may be designed to measure a distinct gaseous species or a group of distinct gaseous species.

The measurement can be taken in real time, i.e. with a measurement duration of less than a few seconds, or even a few minutes. The measurement may alternatively be taken over a longer measurement duration, for example several tens of minutes or even hours.

The measurement can be taken at low concentrations of less than parts per million (ppm) or parts per billion (ppb).

The or each gas analyzer 3 may have an internal pump 7 for taking a gas sample. This may be an internal diaphragm pump.

Two gas analyzers 3 are shown in the illustrative example in FIG. 1. Naturally, this number is not limiting.

The gas analyzers 3 are configured to operate at atmospheric pressure, or substantially at atmospheric pressure.

The operating pressure ranges of gas analyzers are related to the technologies used. The gas analyzers 3 are chosen according to the gas chemistry to be measured, and advantageously other criteria such as response time, reliability, and operating pressure range.

For example, the gas analyzer or analyzers 3 may incorporate one of the following technologies: laser spectroscopy, cavity ring-down spectroscopy (CRDS), mass spectrometry, proton-transfer-reaction mass spectrometry (PTR-MS), ion mobility spectrometry (IMS), electrochemical technology, colorimetric technology, fluorescence spectroscopy, in particular in the ultraviolet (UV) domain, flame ionization detection (FID), chemiluminescence technology, resistive technology, or a system for trapping contamination for subsequent external analysis.

One end of each sampling line L1-Ln is intended to open into a test zone at ambient pressure, i.e. atmospheric pressure. The sampling lines L1-Ln connect the measuring station 1 to distinct test zones, for example in a different location from a clean room. Several sampling lines L1-Ln can open into distinct locations. The length of the sampling lines L1-Ln may vary between the different test zones to be connected, and may be a few meters or several tens of meters long, such as more than 200 m. At least one of the lines L1-Ln may have a minimum length, for example at least 50 m.

The sampling pump 5, also referred to as a drainage pump, is arranged upstream of the gas analyzer or analyzers 3 in the flow direction of the gas flow to be pumped. This pump is for example a diaphragm pump.

The sampling pump 5 has a suction side and a discharge side.

The suction side of the sampling pump 5 is fluidically connected to at least one sampling line L1-Ln. In the example illustrated in FIG. 1, the suction side of the sampling pump 5 is fluidically connected to several sampling lines L1-Ln via a common suction line La.

One or more valves V may be arranged to selectively allow fluidic communication or fluidic isolation between one of the sampling lines L1-Ln and the sampling pump 5. In the example illustrated, a valve V can be arranged on each sampling line L1-Ln.

One or more valves V may be controllable valves, for example solenoid valves or pneumatic valves. Said valves can have all-or-nothing control (open or closed). As a variant or additionally, one or more valves may be three-way valves.

The measuring station 1 may also comprise a control unit C connected to the controllable valves V. The control unit C is configured to provide the control, for example the opening or closing of the valves V, to enable fluidic communication or fluidic isolation between the sampling line or lines L1-Ln and the sampling pump 5.

The discharge side of the sampling pump 5 is fluidically connected to the inlet of the gas analyzer or analyzers 3. The sampling pump 5 and the gas analyzers 3 can thus be brought into fluidic communication with the sampling line or one of the sampling lines L1-Ln.

Where the sampling pump 5 is arranged upstream of several gas analyzers 3, two in the schematic example shown in FIG. 1, these gas analyzers 3 are connected in branches, i.e. in parallel. The gas analyzers 3 are connected to a common line.

This common line is fluidically connected to the discharge side of the sampling pump 5 and is hereinafter referred to as the common discharge line Lr. The inlet of the gas analyzers 3 is thus fluidically connected to the discharge side of the sampling pump 5 via the common discharge line Lr.

This common discharge line Lr may also open for example into a gas treatment system or be fluidically connected to an exhaust or an exhaust line opening, for example, into such a gas treatment system. This makes it possible to evacuate an excess of gas chemistry drawn by the sampling pump 5.

The sampling pump 5 is configured to draw a gas flow from the sampling line L1-Ln. The sampling pump 5 may have a greater pumping capacity than the internal pumps 7 of the gas analyzers. As a purely illustrative example, an internal pump 7 can have a flow rate of between 0.2 L/min and 6 L/min, i.e. between 3.3·10⁻⁶ m³/s and 0.1·10⁻³ m³/s. The sampling pump 5 upstream of the gas analyzer or analyzers 3 may have a flow rate of between 4 L/min and 20 L/min, i.e. between 6.67·10⁻⁵ m³/s and 0.3·10⁻³ m³/s.

The sampling pump 5 is further configured to discharge the gas flow at atmospheric pressure or around atmospheric pressure, i.e. at atmospheric pressure +/−50 hPa, i.e. +/−50 mbar, and preferably +/−30 hPa, i.e. +/−30 mbar.

The gas to be analyzed can thus be taken from the sampling lines L1-Ln by such a pump 5.

The gas analyzers 3 can use their internal pumps 7 to sample a gas flow at the discharge side of the sampling pump 5. Thus, the sampling pump 5 enables a gas flow to be drawn and drained to the gas analyzers 3 for analysis. The gas discharged by the sampling pump 5 at the inlet of the gas analyzers 3 is at atmospheric pressure or substantially at atmospheric pressure. The gas analyzers 3 thus work within their respective operating pressure ranges and can sample the necessary gas flow, with little or no pressure variation (notably less than 50 mbar or 30 mbar) relative to atmospheric pressure, at the inlet of the gas analyzers 3.

At least one pressure gauge 8 may be provided. The pressure gauge 8 may be arranged downstream of the sampling pump 5, being fluidically connected to the discharge side of the sampling pump 5. According to a variant (not shown), a pressure gauge may be arranged upstream of the sampling pump 5.

Furthermore, at least one buffer volume 9 may be arranged downstream of the sampling pump 5 or the pressure gauge 8. The buffer volume 9 is also arranged upstream of the gas analyzer or analyzers 3 in the flow direction of the gas flow to be pumped. The buffer volume 9 is for example between 60 cm³ and 1 dm³, i.e. between 60 mL and 1 L. The buffer volume 9 for example has a generally cylindrical shape.

Such a buffer volume 9 downstream of the sampling pump 5 makes it possible to limit the pressure oscillations that could be generated by the use of the sampling pump 5, such as a diaphragm pump, in relation to the stability of the signal carrying the concentrations measured by the gas analyzer or analyzers 3. Using the buffer volume 9 ensures that the signal has very little noise.

The pressure gauge 8 may be arranged downstream of this buffer volume 9 in the flow direction of the gas flow to be pumped.

The pressure gauge 8 makes it possible to measure the pressure at the outlet of the buffer volume 9 and thus to monitor the oscillation of the pressure variations to ensure that the gas flow supplied to the analyzers 3 is laminar.

At least one restriction 11 may be provided upstream of the sampling pump 5 in the flow direction of the gas flow to be pumped. This makes it possible to limit the gas flow that can be drawn by the sampling pump 5. In other words, the restriction 11 makes it possible to minimize the efficiency of the sampling pump 5, if necessary. Said restriction makes it possible to adjust the suction power of the sampling pump 5, thereby adjusting the total gas flow supplied to the gas analyzers 3. Furthermore, the use of a restriction 11 makes it possible to lower the pressure at the inlet of the sampling pump 5, which makes it possible to optimize the pressure differential between the inlet and the outlet of the sampling pump 5 to best suit the operating speed thereof. Furthermore, limiting the flow of air entering the sampling pump 5 makes it possible to reduce the quantity of air to be compressed and thus to reduce the heating of the sampling pump 5.

The restriction 11 may be chosen notably as a function of the power of the sampling pump 5, the volume thereof, and the number of gas analyzers 3. As a purely illustrative and non-limiting example, for a sampling pump 5 with a flow rate of 20 L/min, the restriction 11 may be configured to limit the flow rate to between 4 L/min and 8 L/min.

The restriction 11 may have a variable opening for the gas flow. The opening of the restriction 11 may be controlled as a function of a pressure measured by the pressure gauge 8 fluidically connected to the discharge side of the sampling pump 5.

The restriction 11 can be achieved in particular by a screw-adjusted flow regulator.

Alternatively, the restriction 11 may for example be a calibrated orifice. This calibrated orifice is connected to the suction side of the sampling pump 5.

Combining the restriction 11 upstream of the sampling pump 5 and the buffer volume 9 downstream of the sampling pump 5 makes it possible to supply a gas flow to the gas analyzer or analyzers 3 under ideal or near-ideal conditions.

One or more of the elements or components of the measuring station 1 upstream of the gas analyzer or analyzers 3 advantageously have internal surfaces that are intended to be in contact with the gases and are made of one or more materials that limit the adhesion of the gaseous species, such as one or more fluoropolymer materials, such as perfluoroalkoxy alkane (PFA) or polytetrafluoroethylene (PTFE), or a perfluoroelastomer (FFKM). Preferably, all of the surfaces in contact with the gases sampled from the inlet of the sampling lines to the gas analyzer or analyzers 3 are made of such a material.

The sampling pump 5 and/or the sampling line or lines L1-Ln and/or the common suction line La and/or the common discharge line Lr and/or the valves V and/or the buffer volume 9 and/or the restriction 11 have such internal surfaces made of a material limiting the adhesion of the gaseous species, such as one or more fluoropolymer materials. Where the sampling pump 5 is a diaphragm pump, this diaphragm is advantageously also made of fluoropolymer material.

Furthermore, the measuring station 1 may comprise at least one flowmeter (not shown). The flowmeter may be arranged downstream of the gas analyzer or analyzers 3 in the flow direction of the gas flow to be pumped.

More precisely, the flowmeter is arranged on the common discharge line Lr downstream of the gas analyzers 3. Thus, where more than one gas analyzer 3 is provided, it is not necessary to duplicate the flowmeter downstream of each gas analyzer 3. Another possible solution is to arrange the flowmeter upstream of all of the gas analyzers 3. The advantage of arranging the flowmeter on the common discharge line Lr downstream of the gas analyzers 3 is that it is not necessary for the internal surfaces thereof to be made of one or more fluorine-enriched materials, such as fluoropolymers.

The flowmeter is configured to measure the flow rate of the gas flow in the common discharge line Lr. This enables monitoring and detection of a possible failure of a gas analyzer 3, or clogging or obstruction. For example, the excess gas flow to be measured by the flowmeter downstream of all the gas analyzers 3 can be determined as a function of the flow rate of the sampling pump 5, the number of gas analyzers 3 and the flow rate of each internal pump 7, and in the event of a discrepancy, notably excessive excess, a failure of one of the gas analyzers 3 can be identified.

In operation, the sampling pump 5 communicates with the sampling line or one sampling line L1-Ln at a time where there are several, and the or each gas analyzer 3 on the discharge side of said sampling pump 5 can take a gas sample to take a measurement.

Thus, the sampling pump 5 drains the contaminated gas flow to be analyzed to the inlet of the gas analyzer or analyzers 3. Whatever the length or diameter of the sampling line L1-Ln or of the common suction line La, before the sampling pump 5, the discharge side of the latter is at atmospheric pressure or substantially at atmospheric pressure. It is therefore the sampling pump 5 that may be subjected to a pressure variation. In contrast to the inlet of the gas analyzer or analyzers 3, the pressure observed is atmospheric pressure +/−50 mbar, preferably +/−30 mbar, and is within the operating range of these gas analyzers 3. This enables gas analyzers 3 that are sensitive to pressure variation to be used. Furthermore, there is no limit to the number of gas analyzers 3 that can be used.

1-15. (canceled)

16. A measuring station for measuring airborne molecular contamination, comprising:
at least two gas analyzers;
at least one sampling line fluidically connected to an inlet of the at least two gas analyzers; and
at least one sampling pump arranged upstream of the at least two gas analyzers in a flow direction of a gas flow to be pumped, wherein
the sampling pump has a suction side fluidically connected to the at least one sampling line and a discharge side fluidically connected to the inlet of the at least two gas analyzers,
the sampling pump is configured to draw the gas flow from the at least one sampling line and to discharge the gas flow at atmospheric pressure +/−50 hPa, and
the discharge side of the sampling pump is fluidically connected to the inlet of the gas analyzers by a common discharge line.

17. The station as claimed in claim 16, wherein the sampling pump is configured to draw the gas flow from the at least one sampling line and to discharge the gas flow at atmospheric pressure +/−30 hPa.

18. The station as claimed in claim 16, wherein the sampling pump has an internal surface made of fluoropolymer.

19. The station as claimed in claim 16, wherein the sampling pump has an internal surface made of perfluoroalkoxy alkane or polytetrafluoroethylene or a perfluoroelastomer.

20. The station as claimed in claim 16, further comprising at least one buffer volume arranged downstream of the sampling pump and upstream of the at least two gas analyzers, in the flow direction of the gas flow to be pumped.

21. The station as claimed in claim 20, wherein the buffer volume is between 60 cm³ and 1 dm³.

22. The station as claimed in claim 20, wherein the buffer volume has an internal surface made of fluoropolymer.

23. The station as claimed in claim 20, wherein the buffer volume has an internal surface made of perfluoroalkoxy alkane or polytetrafluoroethylene or a perfluoroelastomer.

24. The station as claimed in claim 16, further comprising at least one pressure gauge arranged upstream or downstream of the sampling pump.

25. The station as claimed in claim 16, further comprising at least one restriction upstream of the sampling pump in the flow direction of the gas flow to be pumped.

26. The station as claimed in claim 16, wherein the sampling pump is a diaphragm pump.

27. The station as claimed in claim 24, wherein at least one of the at least one sampling line, a restriction upstream of the sampling pump, and the pressure gauge has an internal surface made of fluoropolymer.

28. The station as claimed in claim 24, wherein at least one of the at least one sampling line, a restriction upstream of the sampling pump, and the pressure gauge has an internal surface made of perfluoroalkoxy alkane or polytetrafluoroethylene or a perfluoroelastomer.

29. The station as claimed in claim 16, wherein each of the at least two gas analyzers has an internal pump.

30. The station as claimed in claim 16, wherein at least two of the sampling lines are fluidically connected to a common suction line fluidically connected to the suction side of the sampling pump.

31. The station as claimed in claim 30, further comprising at least one valve configured to selectively allow fluidic communication or fluidic isolation between the sampling pump and at least one of the sampling lines.

32. The station as claimed in claim 31, wherein the common suction line or the at least one valve has an internal surface made of fluoropolymer.

33. The station as claimed in claim 31, wherein the common suction line or the at least one valve has an internal surface made of perfluoroalkoxy alkane or polytetrafluoroethylene or a perfluoroelastomer.

34. The station as claimed in claim 16, further comprising at least one flowmeter arranged on the common discharge line downstream of the gas analyzers in the flow direction of the gas flow to be pumped, the flowmeter being configured to measure a flow rate of the gas flow in the common discharge line.

35. The station as claimed in claim 16, wherein the common discharge line has an internal surface made of fluoropolymer.
